(19) United States
(12) Patent Application Publication
(10) Pub. No.: US 2006/0253251 A1
(43) Pub. Date: Nov. 9, 2006

(54) Method for street name destination address entry using voice

(76) Inventors: Nishikant N. Puranik, Kokomo, IN (US); Mona L. Toms, Camel, IN (US); Randall W. Sencaj, Carmel, IN (US)

Correspondence Address: DELPHI TECHNOLOGIES, INC., M/C 480-410-202, PO BOX 5052, TROY, MI, 48007, US

(21) Appl. No.: 11/125,023

(22) Filed: May 9, 2005

(51) Int. Cl. G01C 21/00

(52) U.S. Cl. 701/211; 701/209; 701/200

(57) ABSTRACT

The present invention relates to an in-vehicle or portable navigation system that can be used to find a destination and determine driving directions to the destination. The present invention also relates to voice-operated navigation systems.

### FIELD OF THE INVENTION

The present invention relates to an automobile or portable navigation system.

### BACKGROUND

In-vehicle and portable navigation systems have been present in the marketplace for several years. Generally, these mobile navigation systems allow the driver or a passenger in the automobile to input the street address of the desired destination to determine a route to the destination. The navigation system typically outputs a series of driving directions through voice prompts or a video screen to guide the driver to the desired destination. Generally, these navigation systems determine the position of the automobile or hand-held device and compare the current position with the destination location to formulate the driving directions. Typically, the navigation system determines the current position of the automobile either through user input or through a locating signal such as Global Positioning System (GPS) signal. The location information for various destinations is generally stored in a database either in the vehicle or at a remote location accessible by a computer in the vehicle. The database typically includes a street name index containing information for each street located in the metropolitan area being searched.

Typically, voice-operated navigation systems require the driver to type in or say the full street name of the street address of the destination when inputting the destination. In such voice enabled systems, the recognition accuracy is inversely proportional to the number of items to be recognized. Therefore a street name in a large metropolitan area will have less recognition accuracy than the same street name in a small town. Additionally, if the metropolitan area being searched contains a large number of street names, for example, Chicago may include in excess of ten thousand street names, the navigation system may require an excessive amount of time to compare the user's audible signal to the street name index to accurately determine the desired destination address.

### SUMMARY OF THE INVENTION

One embodiment of the present invention includes an in-vehicle voice-operated navigation system for determining driving directions to a destination located within a metropolitan area, the navigation system comprising a microphone and voice recognition engine configured to receive an audible signal from a user and output a first identifier corresponding to the audible signal, a database including location information for a plurality of destinations within the metropolitan area, a processor configured to request from the user an identifier of a portion of the metropolitan area that includes the destination and to receive the first signal from the microphone, the processor being further configured to access the database and search the database for the location information of the destination and calculate the driving directions to the destination, and an output configured to communicate the driving directions to the user.

Another embodiment of the present invention includes a method of determining driving directions to guide a user to a destination within a metropolitan area, the method comprising the steps of providing a microphone, a voice recognition engine, a processor, an output, and a database accessible by the processor, the database including location data for a plurality of destinations within the metropolitan area, receiving a first identifier of a portion of the metropolitan area that includes the destination, receiving a second identifier including a street name of the destination, searching the database for the location information of the destination using the first and second identifiers, determining the driving directions, and outputting the driving directions.

Another embodiment of the present invention includes a navigation system for providing driving directions to a driver of a vehicle, the navigation system comprising, a searchable database including a plurality of driving directions, a microphone and voice recognition engine configured to convert an audible signal corresponding to a destination to a first identifier, a locator configured to determine the current location of the vehicle and output a signal corresponding to the current location, a processor configured to receive the first identifier and the signal, search the database for driving directions based on the destination and the current location of the vehicle, and output the driving directions, and an output configured to receive the driving directions and communicate the driving directions to the driver.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram illustrating the components of one embodiment of an in-vehicle navigation system;

FIG. 2 is a flowchart illustrating a method of operating the in-vehicle navigation system shown in FIG. 1;

FIG. 3 is a flowchart illustrating a method of operating the in-vehicle navigation system shown in FIG. 1;

FIG. 4A is a chart defining the portions of a metropolitan area; and

FIG. 4B is a chart defining additional portions of a metropolitan area.

### DETAILED DESCRIPTION OF THE DRAWINGS

The embodiments discussed below are not intended to be exhaustive or limit the invention to the precise forms disclosed in the following detailed description. Rather, the embodiments are chosen and described so that others skilled in the art may utilize their teachings.

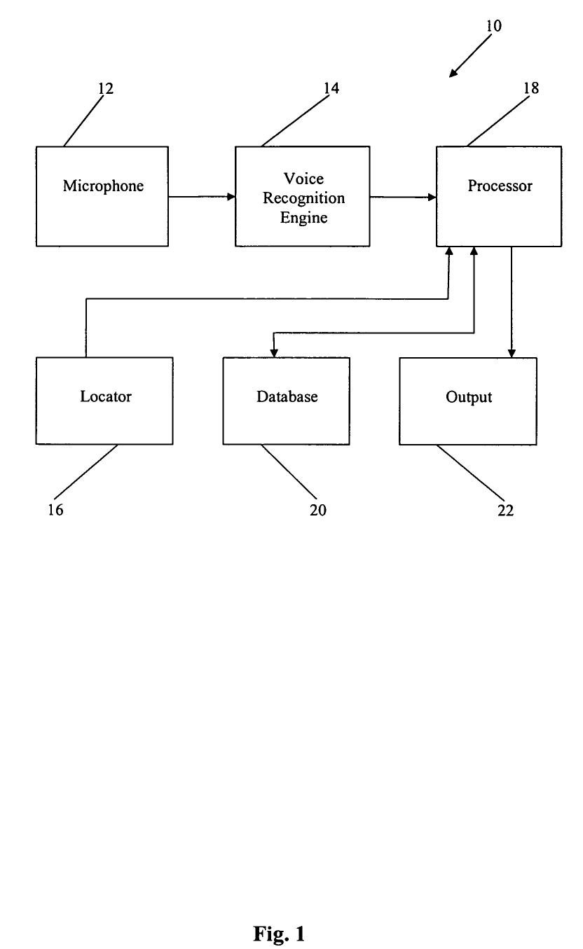

The components of one embodiment of an in-vehicle navigation system 10 are shown in FIG. 1. Navigation system 10 includes microphone 12, voice recognition engine 14, locator 16, processor 18 that includes the application software described below, database 20, and output 22. Processor 18 receives inputs from voice recognition engine 14, locator 16, and database 20 to calculate driving directions, which are communicated to the user by output 22. Microphone 12 receives voice commands from the driver or passenger of the vehicle and outputs a signal to voice recognition engine 14, which outputs an identifier to processor 18. Locator 16 determines the current position of the vehicle and outputs a corresponding signal to processor 18.

In one embodiment, locator 16 is a GPS receiver that uses GPS signals to determine the location of the vehicle. A gyroscope, accelerometer, magnetic compass or wheel speed indicator can also be used individually or in any combination to determine the location of the vehicle. In other embodiments, locator 16 may determine the current position of the vehicle using input from the driver or passenger such as text entry, voice commands, or any other suitable method of inputting information.

Database 20 includes location information for a plurality of locations, which may be selected as a destination by the driver of the vehicle. The location information stored on database 20 may include a street name index, GPS coordinates, latitude and longitude information, airports, landmarks, points of interest, or any other suitable location information. Database 20 may be stored on computer readable media such as a compact disc, a hard drive, a Digital Video Disk (DVD), or any other suitable storage media. In one embodiment, database 20 is present in the vehicle with the other components of navigation system 10. In other embodiments, database 20 is located at a location remote from the vehicle and is accessed by processor 18 through a wireless connection.

Processor 18 receives the identifier from voice recognition engine 14, and searches database 20 for the desired destination spoken by the user. One method of operating navigation system 10 is described below. In one embodiment, processor 18 analyzes the user's spoken destination and compares it to a street name index stored in database 20 to determine the correct destination address. Processor 18 then asks the user to confirm if the destination address found in database 20 is the requested destination. If the user confirms that the destination is correct, processor 18 compares the current position of the vehicle as determined by locator 16 with the location information of the destination from database 20 to determine a route or series of driving directions to guide the driver to the destination. Output 22 receives the driving directions from the processor 18 and communicates the driving directions to the driver. Output 22 may be a reconfigurable screen such as an LCD, a speaker configured to audibly direct the driver, or any other suitable communication means.

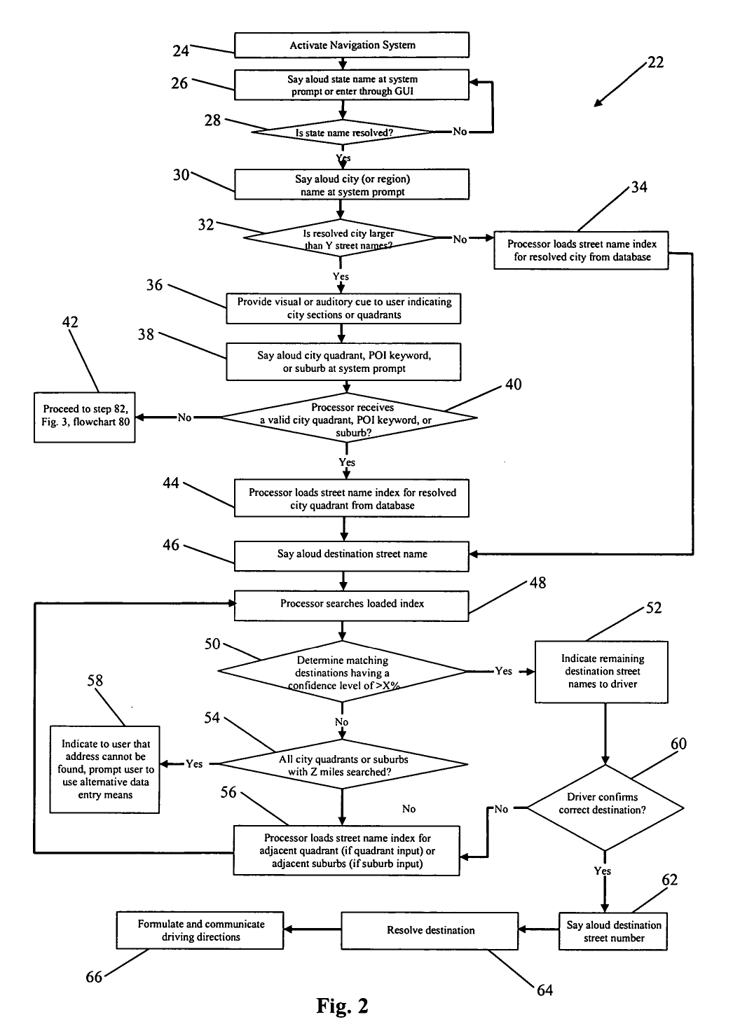

One embodiment of a method of operating navigation system 10 is shown in flowchart 22 in FIG. 2. In step 24, the user, generally the driver or a passenger in the vehicle, activates the navigation system. Activating the system can be done by depressing a designated button, issuing a voice command, or any other suitable means of activation. In step 26, the user says aloud a state name and the method advances to step 28. In step 28, if the state is resolved, the method advances to step 30 in which the user says aloud the name of the city or region in which the desired destination is located after a prompt from the system. If the state name is not resolved in step 28, the method returns to step 26.

In step 32, the processor determines if the desired city or region spoken in step 30 has more than “Y” number of street names. If so, the method proceeds to step 36, if not, the method advances to step 34. In step 34, the processor loads the street name index for the resolved city from the database and the method advances to step 46. In step 36, the system provides a visual or auditory cue to the user indicating city sections or quadrants of the city. The number of street names “Y” in a street name index for a city or region is a predetermined number used to optimize the voice recognition process. Smaller cities having a street name index having, for example, less than 3000 street names can be loaded by the processor and searched effectively without getting further information from the user to narrow the search parameters. As discussed above, larger cities such as Chicago can have 10,000 street names or more and may prompt the user for more information to narrow the search.

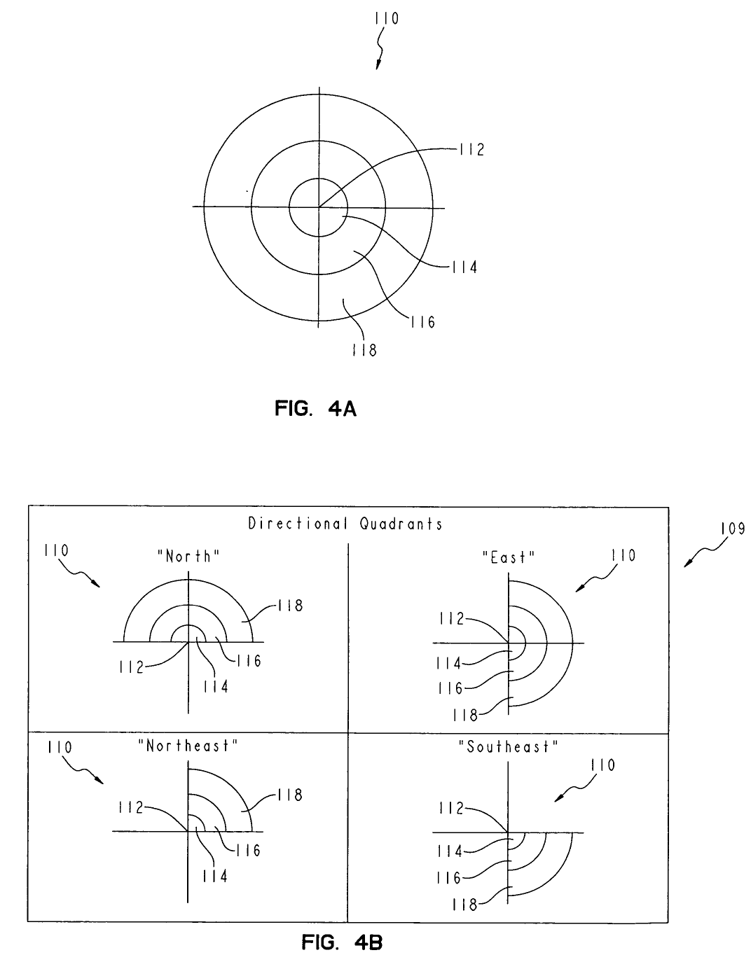

In step 38, the user refers to the visual or auditory cue provided in step 36 and is prompted to say aloud the portion of the metropolitan area such as the quadrant or suburb name encompassing the destination or a keyword indicating a point of interest (POI) located near the destination. For example, a keyword indicating the destination is close to the Indianapolis Motor Speedway in Indianapolis may be “speedway.” A method of defining portions of a metropolitan area is discussed below and in FIGS. 4A and 4B.

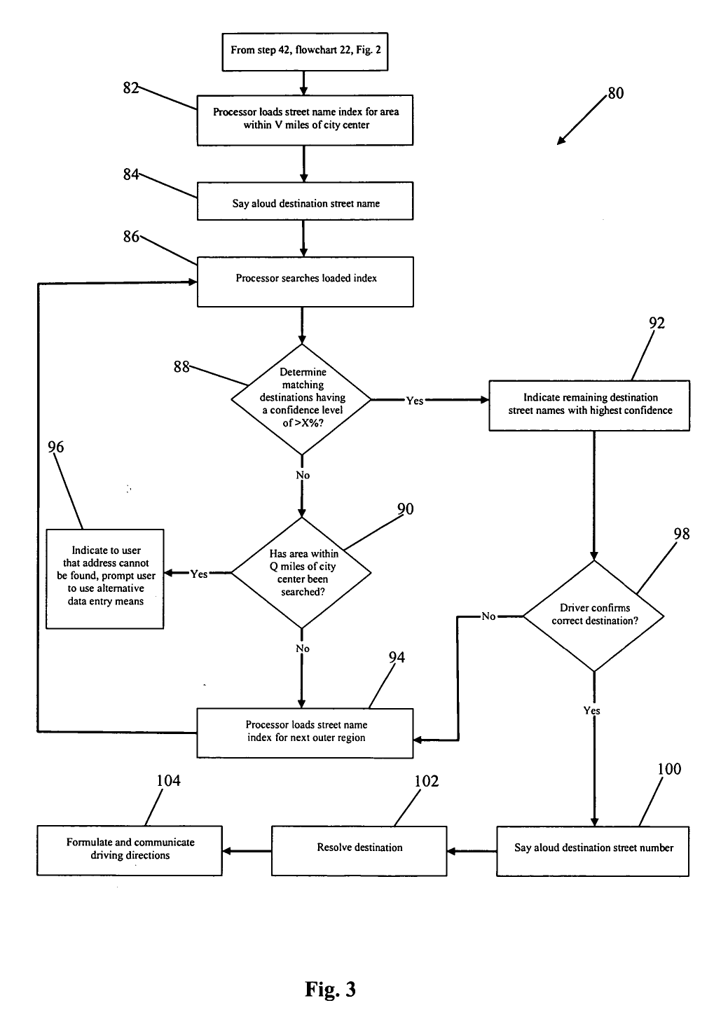

In step 40, the processor determines if a valid city quadrant, suburb, or POI keyword was received. If so, the method advances to step 44. If the user says aloud an invalid suburb or says aloud, for example, “I don't know,” the method advances to step 42. In step 42, the method proceeds to step 82 of flowchart 80 in FIG. 3.

In step 44, the processor loads the street name index for the city quadrant or suburb from step 38 and the method advances to step 46. In step 46, the driver or passenger says aloud the street name of the destination. In step 48, the processor searches the loaded street name index for the destination street name and the method advances to step 50. In step 50, the processor compares the destination street name from step 46 with the loaded street name index to determine if the destination street name matches any street names in the loaded street name index. A predetermined confidence level “X,” for example 85%, is be implemented by the processor to determine the likelihood that the destination street name found in the database is the requested destination street name. If any of the street names found during the search have a confidence level greater than X %, for example greater than 85%, the method proceeds to step 52. If the processor determines that no street names were found having a confidence level greater then X %, i.e. the likelihood that any street address found during the search matches the requested street name is less than X %, the method proceeds to step 54.

In step 54, the processor determines if all city quadrants or suburbs within “Z” miles of the center of the city have been searched. If all of the city quadrants and/or suburbs within “Z” miles of the center of the city have been searched and the destination street is not found the method advances to step 58 which indicates to the user that the street name was not found and prompts the user to enter the address user an alternative method such as typing the address or spelling the street name aloud. In step 54, if there are city quadrants or suburbs within “Z” miles of the center of the city that have not been searched, the method advances to step 56. In step 56, the processor loads the street name index for the portion (city quadrant or suburb) of the metropolitan area that is adjacent to the one selected in step 38 and returns to step 48.

In step 52, the processor communicates all the destination street names having confidence level greater than “X” to the driver. In step 60, if the driver indicates the destination street name found by the processor is incorrect the method advances to step 56. In step 60, if the driver confirms that the correct street name has been selected for the destination, the method proceeds to step 62. In step 62, the driver says aloud the street number portion of the destination address and the method advances to step 64. In step 64, the street number is confirmed the complete destination address is resolved by the system. In step 66, the driving directions are formulated and communicated to the driver through output 22 shown if FIG. 1.

Between steps 48 and 56, the processor loads the street name index for adjacent portions of the metropolitan area such as a quadrant or suburb, one after another, until all the areas within “Z” miles of the center of the particular city or region have been searched.

If the user does not provide proper input in step 40, the method proceeds to step 82 of flowchart 80, as shown in step 42. In step 82 the processor loads a street name index for an area defined by circle having radius of “V” miles (area 114 in FIG. 4A) from the city center (114 in FIG. 4A). In step 84, the user says aloud a destination street name. In step 86, the processor searches for this street name in the loaded street name index and the method advances to step 88. In step 88, if any of the street names found during the search have a confidence level greater than X %, for example greater than 85%, the method proceeds to step 92. If the processor determines that no street names were found having a confidence level greater then X %, the method proceeds to step 90.

In step 90, determines if the area within “Q” miles of the city center has been searched. For example, if “Q” equals 10, processor 18 (shown in FIG. 1) determines if the area defined by a radius of 10 miles from the city center has been searched for the destination street name. If the area within “Q” miles of the city center has been searched, the method advances to step 96. If the processor determines that all of the area within “Q” miles of the city center has been searched, the method advances to step 94. In step 96, the processor indicates to the user that requested address cannot be found using the voice recognition method and prompts the user to use an alternative method of data entry such as typing or spelling the address. In step 94, the processor loads the street name index for the next outer region (area 116 in FIG. 4A) of the metropolitan area that is outside the one selected in step 82 or the previous iteration of step 86 through 94 and returns to step 86. In steps 86 through 94, the processor loads the street name index for the next outer region of the metropolitan area one after the other, until all the areas within “Q” miles of the city center for the particular city or region have been searched or the destination street name is found.

In step 92, the processor communicates street names having confidence level greater than X % to the driver through the output, for example a screen or speaker and the method advances to step 98. In step 98, if the driver confirms that the correct street name has been selected for the destination, the method proceeds to step 100. In step 89, if the driver indicates the destination street name found by the processor is incorrect the method advances to step 94. In step 100, the driver says aloud the street number and the method advances to step 102. In step 102, the street number is confirmed and the complete destination address is resolved by the system. In step 104, the resolved destination address is used to formulate and communicate driving directions to the driver through the output.

The methods of operating a navigation system described above and in FIGS. 2 and 3 can be implemented as computer software operated by a processor in a navigation system or any other suitable means.

Referring now to FIGS. 4A and 4B, one embodiment of a method of reducing the search area for the desired destination by defining portions of a metropolitan area is shown. This method could be used by the navigation system and methods discussed above in FIGS. 1-3. As shown in FIG. 4A, in this embodiment, the center 112 of the metropolitan area 110 is defined as well as concentric bands 114, 116, 118. The center 112 of the metropolitan area can be defined by GPS coordinates, latitudinal and longitudinal coordinates, a landmark, or any other suitable method of defining the center of a metropolitan area. Band 114 is defined as the area having a predetermined radius of, for example, 1 mile from the center 112. For this embodiment, band 116 is defined as the area between 1 mile and, for example, 2 miles from the center 112 of metropolitan area 110. For this embodiment, band 118 is defined as the area between 2 miles and, for example, 3 miles from the center 112 of metropolitan area 110. As would be apparent to one having ordinary skill in the art, fewer or additional bands could be defined and the distance between bands could be varied to reduce or enhance the size of the area defined by the bands.

Referring now of FIG. 4B, chart 109 illustrates examples of a series of directional halves and quadrants, which dissect bands 114, 116, and 118, based on the cardinal directions (north, east, south, west). After a metropolitan area has been determined either by user input or by a locator, the center 112 of the metropolitan area is defined. As shown in step 38 in FIG. 2, a user can then specify a suburb or a cardinal direction (north, east, etc.) relative the center 112 where the destination is believed to be located. To increase recognition accuracy and reduce the amount of time required to search for the destination street name, the processor loads and searches only the street name index for the specified portion rather than for the entire metropolitan area. If the desired destination name is not found, the processor loads the street name index for an adjacent portion of metropolitan area and performs another search.

If the user does not know the general area of the destination, the processor loads the street name index for band 114. If the destination street name is not found, the processor loads the street name index for band 116 and searches for the destination street name. If the destination street name is not found, the processor loads the street name index for band 118 and searches for the destination street name. This process continues until the correct destination street name is found or if a matching street name is not found within a predetermined area us as within “Q” miles of the city center, the user is notified. As would be apparent to one having ordinary skill in the art, alternative methods of dividing a metropolitan area into smaller portions such as by city blocks, square miles, or any other suitable method may be used.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An in-vehicle voice-operated navigation system for determining driving directions to a destination located within a metropolitan area, the navigation system comprising:
a microphone and voice recognition engine configured to receive an audible signal from a user and output a first identifier corresponding to the audible signal;
a database including location information for a plurality of destinations within the metropolitan area;
a processor configured to request from the user an identifier of a portion of the metropolitan area that includes the destination and to receive the first signal from the microphone, the processor being further configured to access the database and search the database for the location information of the destination and calculate the driving directions to the destination; and
an output configured to communicate the driving directions to the user.

2. The navigation system of claim 1, wherein the database includes location information includes location information for a plurality of destinations within a city.

3. The navigation system of claim 1, wherein the database is located at a remote location relative to the vehicle.

4. The navigation system of claim 1, wherein the database is located in the vehicle.

5. The navigation system of claim 1, wherein the output includes a display screen.

6. The navigation system of claim 1, wherein the output includes a speaker.

7. The navigation system of claim 1, further including a locator configured to supply the processor with a current location of the vehicle.

8. The navigation system of claim 1, wherein the identifier is one of at least a city, a city quadrant, a county, a region, a suburb, and a point of interest.

9. A method of determining driving directions to guide a user to a destination within a metropolitan area, the method comprising the steps of:
providing a microphone, a voice recognition engine, a processor, an output, and a database accessible by the processor, the database including location data for a plurality of destinations within the metropolitan area;
receiving a first identifier of a portion of the metropolitan area that includes the destination;
receiving a second identifier including a street name of the destination;
searching the database for the location information of the destination using the first and second identifiers;
determining the driving directions; and
outputting the driving directions.

10. The method of determining driving directions of claim 9, wherein the first identifier is one of at least a quadrant of a city, a county, a region, suburb, and a point of interest.

11. The method of determining driving directions of claim 9, further comprising the steps of:
determining a current location of the user; and
comparing the current location of the user to the location information of the destination to determine the driving directions.

12. A navigation system for providing driving directions to a driver of a vehicle, the navigation system comprising:
a searchable database including a plurality of driving directions;
a microphone and voice recognition engine configured to convert an audible signal corresponding to a destination to a first identifier;
a locator configured to determine the current location of the vehicle and output a signal corresponding to the current location;
a processor configured to receive the first identifier and the signal, search the database for driving directions based on the destination and the current location of the vehicle, and output the driving directions; and
an output configured to receive the driving directions and communicate the driving directions to the driver.

13. The navigation system of claim 12, wherein the output includes a speaker.

14. The navigation system of claim 12, wherein the output includes a display screen.

15. The navigation system of claim 12, wherein the locator includes a GPS receiver.

16. The navigation system of claim 12, wherein the locator is configured to receive an input from a user corresponding to a starting point.

17. The navigation system of claim 12, wherein the database is located at a position remote from the processor.

18. The navigation system of claim 12, wherein the audible signal includes at least one of a state name, a city name, a suburb name, a city quadrant, a point of interest, and a street number.

19. The navigation system of claim 12, further comprising a second database including a searchable street name index configured.

20. The navigation system of claim 19, wherein the voice recognition engine processes the audible signal and searches the second database for a street name corresponding to the audible signal.
